(19) United States
(12) Patent Application Publication
(10) Pub. No.: US 2025/0328053 A1
(43) Pub. Date: Oct. 23, 2025

(54) ELECTROPHORETIC DISPLAY DEVICE

(71) Applicant: E Ink Holdings Inc., Hsinchu (TW)

(72) Inventors: Mondal Somnath, Hsinchu (TW); Wen-Heng Huang, Hsinchu (TW); Po-Yuan Lo, Hsinchu (TW)

(73) Assignee: E Ink Holdings Inc., Hsinchu (TW)

(21) Appl. No.: 18/641,451

(22) Filed: Apr. 22, 2024

(51) Int. Cl. G02F 1/167; G02F 1/1676; G02F 1/1677

(52) U.S. Cl. CPC G02F 1/167; G02F 1/1676; G02F 1/1677

(57) ABSTRACT

An electrophoretic display device including a backplane, a display medium layer, and a multifunctional plate is provided. The display medium layer is disposed on the backplane. The multifunctional plate is disposed on the display medium layer and includes a transparent substrate, a first transparent conductive layer, and a transparent adhesive layer. The first transparent conductive layer is disposed on the transparent substrate. The transparent adhesive layer is disposed on a bottom side of the transparent substrate facing the display medium layer, wherein resistivity of the transparent adhesive layer ranges from 10⁶ ohm-cm to 10¹² ohm-cm. The first transparent conductive layer serves as both an electrode of the display medium layer and an electrode layer of a touch panel.

### BACKGROUND

### Technical Field

The invention generally relates to a display and, in particular, to an electrophoretic display device.

### Description of Related Art

An electrophoretic display is an attractive display technology for its niche applications such as reading and writing devices. An electrophoretic display is composed of several functional layers including a display medium layer, a common driving electrode plane, a barrier film, a touch sensor, a front light guide plate and a cover lens.

A top conducting layer known as a common electrode layer is needed to drive an electrophoretic display panel accurately. The conducting layer is generally formed on a transparent substrate and serves for display operation only. The electrophoretic display needs an additional protection sheet on the top of the display medium layer to prevent moisture damage of the display medium layer. Typically, a touch sensor panel is added on the top of electrophoretic display between the protection sheet and an outer platen to enable touch input. Addition of these functional layers make display module thicker, and make optical performance lower due to more interfacial reflection which is known as optical loss.

### SUMMARY

Accordingly, the invention is directed to an electrophoretic display device, which is thinner and has better optical performance.

According to an embodiment of the invention, an electrophoretic display device is provided. The electrophoretic display device includes a backplane, a display medium layer, and a multifunctional plate. The display medium layer is disposed on the backplane. The multifunctional plate is disposed on the display medium layer and includes a transparent substrate, a first transparent conductive layer, and a transparent adhesive layer. The first transparent conductive layer is disposed on the transparent substrate. The transparent adhesive layer is disposed on a bottom side of the transparent substrate facing the display medium layer, wherein resistivity of the transparent adhesive layer ranges from 10⁶ ohm-cm to 10¹² ohm-cm. The first transparent conductive layer serves as both an electrode of the display medium layer and an electrode layer of a touch panel.

In the electrophoretic display device according to the embodiment of the invention, a multifunctional plate is adopted to replace a plurality of plates respectively having different functions, such as the transparent substrate with the common electrode layer, the protection sheet, and the touch sensor panel, in the conventional electrophoretic display, and the first transparent conductive layer in the electrophoretic display device according to the embodiment of the invention serves as both an electrode of the display medium layer and an electrode layer of a touch panel. As a result, the electrophoretic display device according to the embodiment of the invention is thinner, and interfacial reflection thereof is less so that optical performance thereof is better.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of an electrophoretic display device according to an embodiment of the invention.

FIG. 2 is a schematic cross-sectional view of an electrophoretic display device according to another embodiment of the invention.

FIG. 3A and FIG. 3B is schematic cross-sectional views showing manufacturing steps of the transparent adhesive layer in FIG. 2.

FIG. 4 is a schematic cross-sectional view of an electrophoretic display device according to another embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

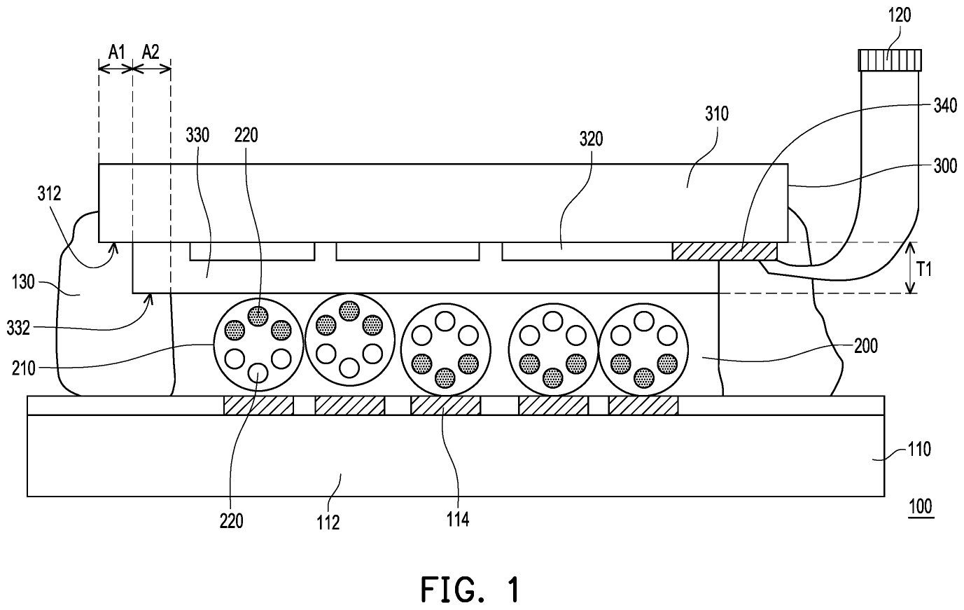

FIG. 1 is a schematic cross-sectional view of an electrophoretic display device according to an embodiment of the invention. Referring to FIG. 1, the electrophoretic display device 100 in this embodiment includes a backplane 110, a display medium layer 200, and a multifunctional plate 300. The display medium layer 200 is disposed on the backplane 110. In this embodiment, the backplane 110 includes a circuit substrate 112 and a plurality of pixel electrodes 114 disposed on the circuit substrate. The display medium layer 200 is an electroactive layer, which is an electrophoretic layer, for example. In this embodiment, the display medium layer 200 includes ink slurry with a plurality of capsules 210 and a plurality of electrophoretic particles 220 inside the capsules 210. In detail, each capsule 210 contains a plurality of electrophoretic particles 220, and the electrophoretic particles 220 may include a plurality of black electrophoretic particles and a plurality of white electrophoretic particles. In other embodiments, the electrophoretic particles 220 may include a plurality of electrophoretic particles with other colors, for example, red, green, and blue colors.

The multifunctional plate 300 is disposed on the display medium layer 200 and includes a transparent substrate 310, a first transparent conductive layer 320, and a transparent adhesive layer 330. The first transparent conductive layer 320 is disposed on the transparent substrate 310. The transparent adhesive layer 330 is disposed on a bottom side of the transparent substrate 310 facing the display medium layer 200, wherein resistivity of the transparent adhesive layer 330 ranges from 10⁶ ohm-cm to 10¹² ohm-cm. In this embodiment, the material of the transparent adhesive layer 330 is, for example, polyurethane adhesive doped with 500 ppm of tetrabutylammonium hexafluorophosphate (TBAHPF). [U.S. Pat. No. 7,012,735] The first transparent conductive layer 320 serves as both an electrode of the display medium layer 200 and an electrode layer of a touch panel.

When a voltage is applied between a pixel electrode 114 and the first transparent conductive layer 320, the electrophoretic particles 220 in the capsule 210 between the pixel electrode 114 and the first transparent conductive layer 320 move and are redistributed, so that the gray level or the color of the pixel defined by the pixel electrode 114 changes. In this way, the image provided by the electrophoretic display device may be changed by controlling voltages applied to the pixel electrodes 114, respectively. In an embodiment, the first transparent conductive layer 320 serves as both a common electrode of the display medium layer 200 and the electrode layer of the touch panel.

In the electrophoretic display device 100 in this embodiment, a multifunctional plate 300 is adopted to replace a plurality of plates respectively having different functions, such as the transparent substrate with the common electrode layer, the protection sheet, and the touch sensor panel, in the conventional electrophoretic display, and the first transparent conductive layer 320 in the electrophoretic display device 100 in this embodiment serves as both an electrode of the display medium layer 200 and an electrode layer of a touch panel. As a result, the electrophoretic display device 100 in this embodiment is thinner, lighter, and robust, and interfacial reflection thereof is less so that optical performance thereof and reliability thereof is better. In this embodiment, a water vapor transmission rate (WVTR) of the transparent substrate is less than 0.1 g/m²/day at room temperature, so that the multifunctional plate 300 also has a protection function in addition to a display electrode function and a touch sensing function. In an embodiment, the room temperature is 27° C. In this embodiment, the transparent substrate 310 is a glass substrate, which can have a WVTR less than 0.1 g/m²/day at room temperature. However, in other embodiments, the transparent substrate 310 is a plastic substrate coated with at least one organic or inorganic layer; for example, the plastic substrate may be a polyethylene terephthalate (PET) substrate, and the organic layer and the inorganic layer may be a resin layer and a silicon nitride layer. The at least one organic or inorganic layer may be disposed on the bottom side of the plastic substrate facing the display medium layer 200 or on the top side of the plastic substrate facing away from the display medium layer 200. The at least one organic or inorganic layer help the transparent substrate 310 to have a WVTR less than 0.1 g/m²/day at room temperature.

In addition, transparent adhesive layer 330 is used to aid lamination, so that significant bubbles do not exist between the display medium layer 200 and the transparent substrate 310. In this embodiment, a thickness T1 of the transparent adhesive layer 330 ranges from 5 microns to 50 microns, and is preferably 25 microns.

In this embodiment, the first transparent conductive layer 320 is segmented or patterned for touch sensing. In this embodiment, the multifunctional plate 300 further includes at least one metal trace 340 configured to electrically connect the first transparent conductive layer 320 with a controller 120. The controller 120 may control voltages applied to the pixel electrodes 114 and the first transparent conductive layer 320.

In this embodiment, the electrophoretic display device 100 in this embodiment further includes an edge sealant 130 surrounding the display medium layer 200 and connecting the multifunctional plate 300 with the backplane 110, wherein the edge sealant 130 touches both a part of a bottom surface 312 (e.g. the edge of the bottom surface 312) of the transparent substrate 310 facing the backplane 110 and a part of a bottom surface 332 (e.g. the edge of the bottom surface 332) of the transparent adhesive layer 330 facing the backplane 110. In addition, in this embodiment, an area A1 of the edge sealant 130 touching the part of the bottom surface 312 of the transparent substrate 310 is larger than an area A2 of the edge sealant 130 touching the part of the bottom surface 332 of the transparent adhesive layer 330.

In this embodiment, a size of the multifunctional plate 300 is smaller than a size of the backplane 110 but larger than a size of the display medium layer 200. In this embodiment, an area of the transparent adhesive layer 330 is smaller than an area of the transparent substrate 310 but larger than an area of the display medium layer 200.

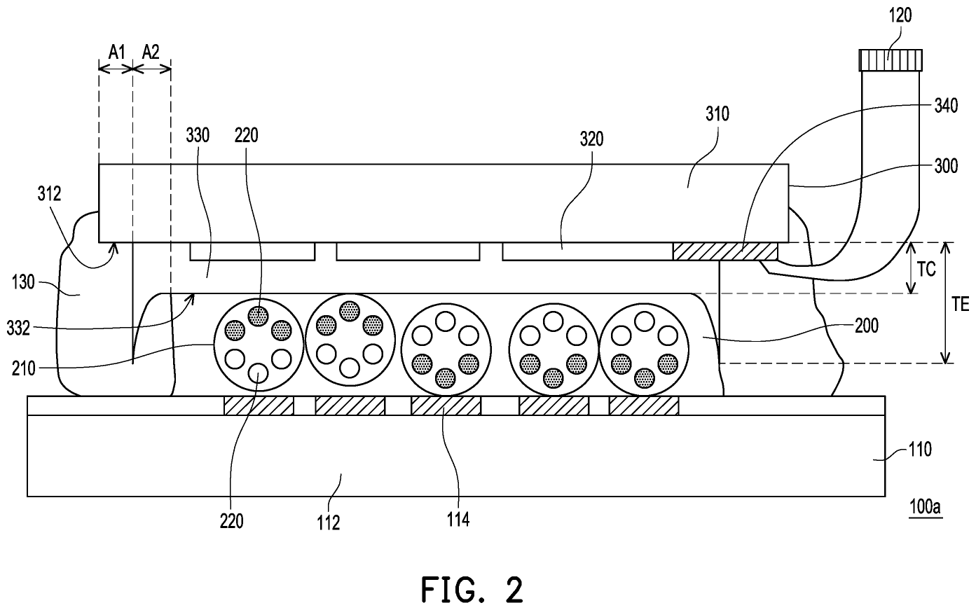

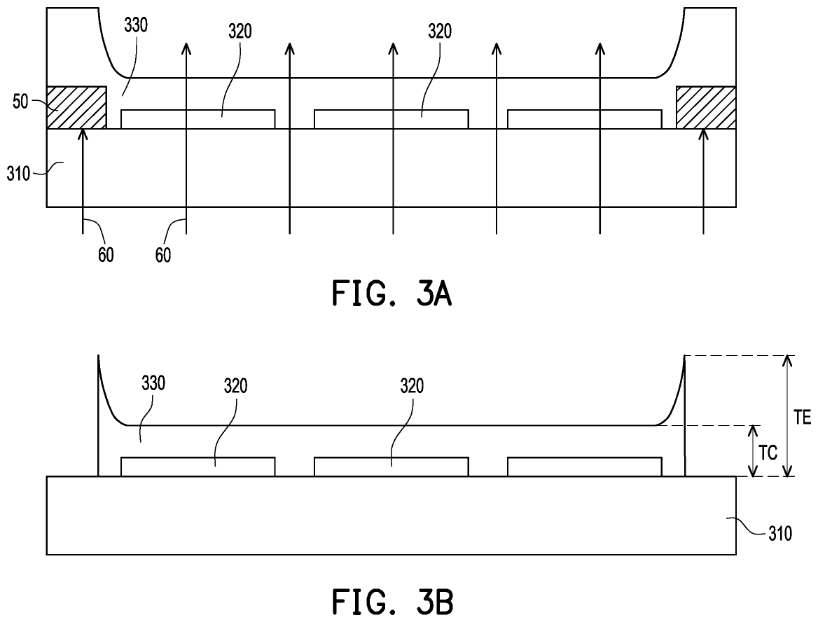

FIG. 2 is a schematic cross-sectional view of an electrophoretic display device according to another embodiment of the invention, and FIG. 3A and FIG. 3B is schematic cross-sectional views showing manufacturing steps of the transparent adhesive layer in FIG. 2. Referring to FIG. 2, FIG. 3A, and FIG. 3B, the electrophoretic display device 100a in this embodiment is similar to the electrophoretic display device 100 in FIG. 1. However, in the electrophoretic display device 100a in this embodiment, a thickness TE of the transparent adhesive layer 330 at an edge thereof is greater than a thickness TC of the transparent adhesive layer 330 at a central part thereof. In the process of forming the transparent adhesive layer 330, the transparent adhesive layer 330 is patterned by a masking process. The following Examples are now given, though by way of illustration only, to show details of particularly preferred techniques used in this present invention.

### Example 1

Referring to FIG. 3A, a mask 50 is formed or disposed at the edge of the transparent substrate 310. Then, a transparent adhesive layer 330 is formed on the transparent substrate 310 and cover the mask 50. Next, a main part of the transparent adhesive layer 330 other than the edge part thereof is exposed to light 60 from the bottom of FIG. 3A. The edge part of the transparent adhesive layer 330 is not exposed to light 60 because the mask 50 blocks the light 60 from the bottom of FIG. 3A. In this embodiment, the transparent adhesive layer 330 is, for example, a negative photoresist. After that, referring to FIG. 3B, the edge part of the transparent adhesive layer 330 not exposed to light 60 is removed by a developing agent, and the mask 50 is also removed, and the process of forming the transparent adhesive layer 330 in FIG. 2 is completed.

### Example 2

This example illustrates the process of forming the transparent adhesive layer 330, using thermal curable adhesive, for example, water based polyurethane adhesive with water-soluble sorbitol polyglycidyl ether as crosslinking agent. In this embodiment, the process of Example 1 above were repeated with thermal curable adhesive to form transparent adhesive layer 330 on the transparent substrate 310 and cover the mask 50, as shown in FIG. 3A. Next, the materials are cured at high temperature for certain amount of time to form crosslinked adhesive, wherein curing temperature ranges from 40° C. to 200° C., preferably at 80° C. In this embodiment, a curing time ranges from 10 minutes to 120 minutes, and is preferably 40 minutes. Next, the mask 50 is removed by mechanical peeling and the process of forming the transparent adhesive layer 330 in FIG. 2 is completed. It will be apparent to those skilled in the art that wide variety of water or solvent soluble crosslinking agent can be used in the specific embodiments of the invention described above without departing from the scope of the invention. Accordingly, the whole of the foregoing description is to be interpreted in an illustrative and not in a limitative sense.

In the process of forming the transparent adhesive layer 330, since the mask 50 has a height, the edge part of the transparent adhesive layer 330 is higher than the main part of the transparent adhesive layer 330. As a result, after the edge part of the transparent adhesive layer 330 is removed, the thickness TE of the remaining part of the transparent adhesive layer 330 at the edge thereof is also greater than the thickness TC of the remaining part of the transparent adhesive layer 330 at the central part thereof. Therefore, the area of the transparent adhesive layer 330 is larger than the area of the display medium layer 200, so that the larger thickness at the edge of the transparent adhesive layer 330 does not damage the display medium layer 200.

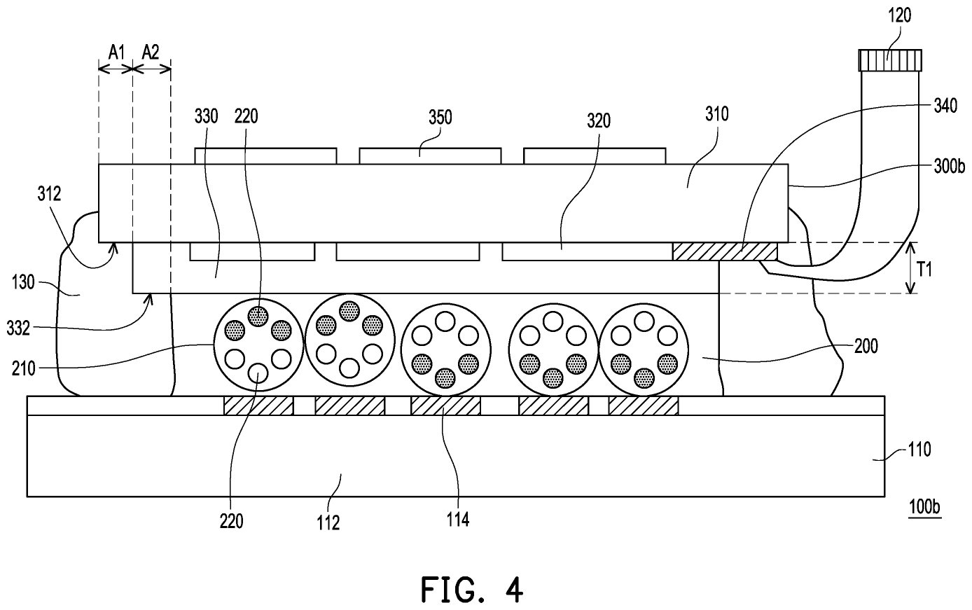

FIG. 4 is a schematic cross-sectional view of an electrophoretic display device according to another embodiment of the invention. Referring to FIG. 4, the electrophoretic display device 100b in this embodiment is similar to the electrophoretic display device 100 in FIG. 1, and the main difference therebetween is as follows. In the electrophoretic display device 100b in this embodiment, the multifunctional plate 300b further includes a second transparent conductive layer 350 disposed on the top side of the transparent substrate 310 facing away from the display medium layer 200, and the second transparent conductive layer 350 serves as an electrode layer of a touch panel.

In conclusion, in the electrophoretic display device according to the embodiment of the invention, a multifunctional plate is adopted to replace a plurality of plates respectively having different functions, such as the transparent substrate with the common electrode layer, the protection sheet, and the touch sensor panel, in the conventional electrophoretic display, and the first transparent conductive layer in the electrophoretic display device according to the embodiment of the invention serves as both an electrode of the display medium layer and an electrode layer of a touch panel. As a result, the electrophoretic display device according to the embodiment of the invention is thinner, and interfacial reflection thereof is less so that optical performance thereof is better.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electrophoretic display device comprising:
a backplane;
a display medium layer disposed on the backplane; and
a multifunctional plate disposed on the display medium layer and comprising:
a transparent substrate;
a first transparent conductive layer disposed on the transparent substrate; and
a transparent adhesive layer disposed on a bottom side of the transparent substrate facing the display medium layer, wherein resistivity of the transparent adhesive layer ranges from 10⁶ ohm-cm to 10¹² ohm-cm,
wherein the first transparent conductive layer serves as both an electrode of the display medium layer and an electrode layer of a touch panel.

2. The electrophoretic display device according to claim 1, wherein an area of the transparent adhesive layer is smaller than an area of the transparent substrate but larger than an area of the display medium layer.

3. The electrophoretic display device according to claim 1, wherein a thickness of the transparent adhesive layer ranges from 5 microns to 50 microns.

4. The electrophoretic display device according to claim 1, wherein a thickness of the transparent adhesive layer at an edge thereof is greater than a thickness of the transparent adhesive layer at a central part thereof.

5. The electrophoretic display device according to claim 1, wherein a water vapor transmission rate of the transparent substrate is less than 0.1 g/m²/day at room temperature.

6. The electrophoretic display device according to claim 1, wherein the transparent substrate is a glass substrate.

7. The electrophoretic display device according to claim 1, wherein the transparent substrate is a plastic substrate coated with at least one organic or inorganic layer.

8. The electrophoretic display device according to claim 1, wherein the first transparent conductive layer is disposed on the bottom side of the transparent substrate facing the display medium layer.

9. The electrophoretic display device according to claim 8, wherein the multifunctional plate further comprises a second transparent conductive layer disposed on a top side of the transparent substrate facing away from the display medium layer.

10. The electrophoretic display device according to claim 1, wherein the first transparent conductive layer is segmented or patterned for touch sensing.

11. The electrophoretic display device according to claim 1, wherein the first transparent conductive layer serves as both a common electrode of the display medium layer and the electrode layer of the touch panel.

12. The electrophoretic display device according to claim 1, wherein the multifunctional plate further comprises a metal trace configured to electrically connect the first transparent conductive layer with a controller.

13. The electrophoretic display device according to claim 1, wherein a size of the multifunctional plate is smaller than a size of the backplane but larger than a size of the display medium layer.

14. The electrophoretic display device according to claim 1 further comprising an edge sealant surrounding the display medium layer and connecting the multifunctional plate with the backplane, wherein the edge sealant touches both a part of a bottom surface of the transparent substrate facing the backplane and a part of a bottom surface of the transparent adhesive layer facing the backplane.

15. The electrophoretic display device according to claim 1, wherein an area of the edge sealant touching the part of the bottom surface of the transparent substrate is larger than an area of the edge sealant touching the part of the bottom surface of the transparent adhesive layer.
